(19) United States
(12) Patent Application Publication
(10) Pub. No.: US 2009/0216834 A1
(43) Pub. Date: Aug. 27, 2009

(54) METHOD FOR COMMUNICATING WITH SEVERAL USERS, ARRANGEMENT, COMMUNICATION MANAGEMENT SERVER, AND COMMUNICATION TERMINAL

(75) Inventors: Frank-Uwe Andersen, Berlin (DE); Christian Herzog, Berlin (DE); Thomas Lüde, Berlin (DE)

Correspondence Address: LERNER GREENBERG STEMER LLP, P O BOX 2480, HOLLYWOOD, FL, 33022-2480, US

(73) Assignee: Nokia Siemens Networks GmbH & Co. KG, Munchen (DE)

(21) Appl. No.: 12/161,923

(22) PCT Filed: Jan. 10, 2007
(86) PCT No.: PCT/EP2007/050204

§ 371 Date: Feb. 19, 2009

(30) Foreign Application Priority Data
Jan. 27, 2006 (DE) 10 2006 004 819.9

(51) Int. Cl. G06F 15/16

(52) U.S. Cl. 709/203; 707/100; 709/206; 707/10

(57) ABSTRACT

Disclosed is a method for communicating with several users in order to improve the usability of a communication system involving several users. Said method comprises the following steps to record a communication between the several users utilizing several communication services (3-8; 23-28) in chronological sequence: a request message is transmitted from a communication terminal (1; 21) of one of the users to a communication management server (10; 30); the communication management server (10; 30) assigns an identity to the communication, and the request message is answered by transmitting the identity to the communication terminal (1; 21); the respective communication terminal (1; 21) marks messages that are output via the different communication services (3-8; 23-28) of the several users' communication terminals (1; 21) with the identity, and the messages that are output via the different communication services (3-8; 23-28) and are marked with the identity are recorded so as to be retrievable via the identity. The invention further relates to an arrangement, a communication management server (10; 30), and a communication terminal (1; 21) for carrying out a communication method involving several users.

### CLAIM FOR PRIORITY

This application is a national stage application of PCT/EP2007/050204, filed Jan. 10, 2007, which claims the benefit of priority to German Application No. 10 2006 004 819.9, filed Jan. 27, 2006, the contents of which hereby incorporated by reference.

### TECHNICAL FIELD OF THE INVENTION

The invention relates to a method for communicating with several users.

### BACKGROUND OF THE INVENTION

In the age of modern, particularly also mobile telecommunication, the possibility exists that a communication with possibly closely linked content between a number of users uses in a chronological sequence, i.e. successively, different communication services. Such communication services can be, for example, a Push-to-Talk-Over-Cellular (PoC) service, an Instant Messaging (IM) service, an email service, a telephone service, a video telephony service, a Short Message Service (SMS) or a Multimedia Messaging Service (MMS). As part of a communication, messages can thus be exchanged between communication terminals of the users by using these or also further communication services.

### SUMMARY OF THE INVENTION

According to one embodiment of the invention, there is a method for communicating with several users for recording a communication between the several users using various communication services:

Sending a request message from a communication terminal of one of the users to a communication management server, assigning an identity to the communication via the communication management server and answering the request message by conveying the identity to the communication terminal, marking messages, output via the various communication services of the communication terminals of the several users, with the identity by the respective communication terminal and recording the messages, output via the various communication services and marked with the identity, in such a manner that they can be retrieved via the identity.

One advantage of the invention is that a recording of the communication takes place by using the different communication services. In this process, the messages associated with the communication can be retrieved in each case via the identity. Thus, for example, a communication about a particular subject which, for instance, begins by messages in the form of an email exchange between two friends and continues via further messages in the form of telephone calls and by using an instant messaging service can be recorded.

Recording the communication or the messages of the communication marked with the identity advantageously creates the prerequisite for the most varied applications which can use the recorded communication consisting of messages of the most varied communication services. In this context, the recorded communication can be used both by the users of the communication themselves and by other users.

Another advantage according to the invention is that the communication management server provides a central component which handles the management of the messages of the communication to be recorded. In this context, the communication management server can be arranged both within a communication network and covering a number of communication networks. On request by the communication terminal of one of the users, the communication management server assigns an identity to the communication, i.e. a new communication is set up or arranged. The identity which unambiguously identifies the communication is conveyed to the requesting communication terminal by the communication management server. This advantageously makes it possible for messages output via the various communication services of the communication terminals of a group of users to be marked by the identity. On the basis of the identity, the messages output via the various communication services and marked by the identity can be recorded in such a manner that they can be retrieved via the identity. This means that the messages are linked by the identity to form a multi-service communication, i.e. one that comprises the messages of a number of communication services.

A user of the communication can also use a number of communication terminals, i.e. in this case, the user determines in dependence on the respective communication service which one of his communication terminals is to be used for this communication service. In addition, it should be noted that, naturally, not all messages output via the various communication services of the communication terminals of the several users are marked with the identity but only those which are to be allocated to the relevant communication. Furthermore, a user, and thus also his communication terminal, can be involved simultaneously in a number of communications, i.e. whilst a first message output is allocated to a communication A by means of a corresponding identity, a second message output can be allocated to a communication B by means of a further identity.

In one embodiment according to the invention, the messages output via the various communication services and marked with the identity are recorded by the communication management server. This embodiment is advantageous since the communication management server already handles the management of the issuing of the identities for the communications. Furthermore, this provides the possibility of recording the messages output via the various communication services in such a manner that existing services are not influenced, or influenced as little as possible, which significantly facilitates the introduction of the method.

In another embodiment according to the invention, the outgoing messages marked with the identity are additionally conveyed by the communication terminals to the communication management server. This is advantageous since this provides a simple possibility for the communication management server to record the messages output via the various communication services. The messages output are preferably conveyed to the communication management server by the communication terminals by the communication management server additionally being included in the receiver list of the message.

This is possible, for example, for those communication services in which single messages are transmitted as self-contained units. Examples of these are emails, SMS, MMS or messages of an Instant Messaging Service. For other communication services such as, for example, a circuit-switched service, for instance in the form of a voice-based telephone call, the possibility preferably exists that the communication terminal which wishes to dispatch a message sets up a conference circuit in which the communication management server is included as additional user. This advantageously makes it possible that the communication management server can also record those messages.

According to the invention, those sections of a communication in which information is transmitted bidirectionally between the users, such as, for example, a telephone call using a conventional telephone service, are also called messages. In this case, the term “message” includes the entire corresponding communication section, i.e., for example, the entire telephone call.

The message output is preferably marked with the identity in that the identity is embedded in the respective message. Such in-band signaling can be provided, for example, in the case of text-based communication services by means of a character strings at the beginning of the message text. In the case of a telephone call, the user setting up the call preferably first calls the communication management server by means of his communication terminal and conveys to it the identity, for example by means of the DTMF (Dual Tone Multiple Frequency) method. Afterward, the other users of the telephone call can be called and the conference circuit can be set up. Such in-band signaling offers the advantage that the actual conversation is not disturbed and no changes of the protocols used are required. In addition, it can be used universally without the various communication services having to meet special requirements. In particular, existing communication services such as, for example, an email service, does not have to be adapted when using in-band signaling, as a result of which maximum compatibility with existing communication services is advantageously achieved.

In still another embodiment, out-of-band signaling can also be used for individual or all of the communication services for conveying the identity, for example in the form of additional information in the header of a message. Corresponding information can then be evaluated, in turn, by the communication management server and used for recording the messages output via the various communication services, in such a manner that they can be retrieved via the identity.

Apart from the possibilities for conveying the identity of the messages to the communication management server, described above, there is additionally preferably also the possibility of switching, apart from the transmission of the actual message, an additional connection between the respective communication terminal and the communication management server via which the identity is signaled.

The invention may also be arranged in such a manner that the conveying of the messages marked with the identity to the communication management server is provided free of costs in the charging system. This is of advantage especially for those communication services in which the charging is based on the number of messages actually transmitted by a communication terminal such as, for example, in an SMS service, since the user avoids additional charges and thus the user's inhibition threshold for using the method is lowered.

In another embodiment, the invention proceeds in such a manner that the messages output via the various communication services and marked with the identity are recorded by a service center providing the respective communication service at the network end. This is thus a decentralized embodiment in which the service centers providing the various communication services are extended in such a manner that they record the messages output via the respective communication service and marked by the identity. This is advantageous since, as a result, the load of recording the messages is distributed over the various service centers. To trigger the recording of the corresponding messages, the identity is signaled to the service center by the relevant communication terminal preferably in the setting-up phase of the respective communication service. The messages are preferably recorded by the service center in a separate database which is not identical to the database used by the service center for providing the actual communication service. This advantageously achieves a decoupling of the provision of the respective service from the functionality of recording the messages and from the communication management server at the network end. The decoupling can be preferably extended to such an extent that the interface between the respective communication service and the database used for recording the messages is unidirectional so that the service center only has the ability of a write access which eliminates any impairment of the provision of the communication service by the service center. In this embodiment, the advantageous possibility also exists that for those service centers which do not support the recording of the messages marked with the identity, the recording is provided by the communication management server whereas service centers which do support the functionality of recording themselves record the relevant messages.

According to still another embodiment of the invention, the service center informs the communication management server about the messages marked with the identity. This is advantageous since it enables the communication management server to manage the communication and the respective messages allocated by means of the identity even when the messages are recorded by the service center providing the respective communication service.

According to the invention, the communication terminal sending out the respective message output and marked with the identity informs the communication management server about the message marked with the identity. This advantageously avoids a change of the service center for informing the communication management server about the messages marked with the identity.

In another preferred embodiment according to the invention, a retrieval message is sent to the communication management server and the communication management server answers by conveying the identity of the communication and/or of a list of the messages belonging to the communication and marked with the identity. In this context, the retrieval message is preferably sent by one of the communication terminals of the several users. In this arrangement, a suitable interface, for example in the form of a web browser is advantageously provided which facilitates the sending of the retrieval message. The retrieval message can be preferably formulated in the form of a search operation wherein it is possible to search for various criteria such as, for example, the identity of the communication, the users of the communication or the content of the communication.

The invention is preferably formed such that a replay request is sent to the communication management server and the latter replays one or several of the messages marked with the identity. In this context, the replay is preferably provided either by the communication management server directly accessing the messages recorded by it or by the communication management server requesting the corresponding messages from the service centers providing the communication services. This is required if the messages are not recorded by the communication management server itself but by the respective service center. The described embodiment of the method according to the invention is advantageous since it enables both the users of the relevant communication and other users to listen to or view individual, several or all messages belonging to the communication. This advantageously enables other users to inform themselves about the progress of the communication until then. If they wish, the other users can enter into the communication on the basis of the current state of the communication. The possibility of a central subsequent interrogation of the messages belonging to a communication, comprising all communication services used, is also of advantage to the users of the communication themselves.

In still another embodiment according to the invention, the communication management server, for sending the messages marked with the identity, manages a receiver list, allocated to the identity, with addresses of the users currently involved in the communication. This provides the advantage that the communication management server, as central component, can handle the management of the receiver list. In this context, the addresses, specific to the respective communication service, of the users currently involved in the communication are preferably entered in the receiver list.

In a preferred embodiment according to the invention, the receiver list is set up by the communication management server concurrently with the assignment of the identity. In this context, the communication terminal requesting the identity is advantageously automatically included in the receiver list via the communication management server.

In a further preferred embodiment, the invention proceeds in such a manner that the identity of an existing communication is conveyed by a communication terminal of a further user, together with address information of the further user to the communication management server, and the communication management server enters an address or several addresses of the other user in the receiver list. This corresponds to a subscription to a communication in the form of which future messages which are marked with the identity of the communication are conveyed to the further user. Analogously, it is advantageously possible that a user of a communication deregisters at the communication management server, specifying the identity of the communication and the address or the addresses of the relevant user are thereupon deleted from the receiver list so that future messages of the communication are no longer conveyed to the user.

In another preferred embodiment of according to the invention, the communication management server determines from the address information the address or the addresses by using the so-called ENUM functionality. In this context, the ENUM functionality is known from the “Request for Comments RFC 3761” of the IETF (Internet Engineering Task Force, see www.ietf.org). ENUM enables different communication services to be provided under one directory number. This advantageously reduces or avoids the expenditure for conveying the addresses of the users, which, as a rule, are specific to the respective communication service.

The invention preferably proceeds such that the communication management server informs the communication terminals of the users about changes in the receiver list. This is advantageous since the communication terminals can thus send all messages output to the receiver list which is current at the respective time.

According to the invention, it is advantageously designed such that the communication terminals, before sending the messages marked with the identity, retrieve the receiver list from the communication management server. This embodiment is preferred since additional storing of the receiver list in the communication terminals is avoided.

The invention is advantageously arranged such that, in addition to the content of the messages marked with the identity, information relating to the time and/or to the receivers of the messages is recorded. This is advantageous since this enables the communication management server to indicate additional information to the respective messages. This makes it easier for a user who wishes a message or a number of messages to be replayed to make a selection of those messages which he wishes to view and/or to listen to.

According to yet another embodiment of the invention, a communication is provided with a validity period, after the expiry of which the communication or individual messages of the communication marked with the identity are deleted. In this context, the validity period is advantageously conveyed already when a communication is set up, i.e. when an identity is assigned to the relevant communication by the communication management server, from the relevant communication terminal to the communication management server. This advantageously enables the communication management server to delete a communication with expired validity period or older messages within a communication.

In a further preferred embodiment according to the invention, reading and writing of the messages of the communication marked with the identity is regulated by access rights. This provides the advantage that a communication can either be made available only to a restricted circle of users or, alternatively, publically accessible to any users. The access rights can thus be advantageously adapted to the degree of confidentiality desired for the respective communication.

The communication services used can be any communication services suitable for communication. In a preferred embodiment of the method according to the invention, a Push-to-Talk-Over-Cellular (PoC) service, an Instant Messaging (IM) service, an email service, a telephone service, a video telephony service, a Short Message Service (SMS) or a Multimedia Messaging Service (MMS) is used as one of the various communication services. This is advantageous since said services are widely used communication services.

In yet another embodiment according to the invention, a mobile communication terminal of a mobile radio network is used as at least one of the communication terminals. In this context, the mobile communication terminal can be, for example, a mobile radio telephone or a laptop or a personal digital assistant (PDA) with radio interface. Furthermore, however, stationary communication terminals can also be used, for example in the form of a workstation computer.

In addition, the invention relates to an arrangement for carrying out a communication method involving a number of users.

In another embodiment of the invention, there is an arrangement for carrying out a communication method involving several users, for recording a communication using various communication services in chronological sequence, between the several users comprising communication terminals allocated to the several users which in each case provide at least one of the communication services, and a device for sending a request message to a communication management server for assigning an identity to the communication, a device for receiving the identity from the communication management server and means for marking with the identity messages output via the at least one communication service, the communication management server which has means for receiving the request message from one of the communication terminals, means for assigning the identity to the communication and a device for answering the request message by transmitting the identity to the relevant communication terminal, and comprising a device for recording the messages output via the various communication services and marked with the identity, in such a manner that they can be retrieved via the identity.

The arrangement according to the invention is preferred since it enables the messages of the communication to be recorded. This takes place covering the several communication services which, compared with a communication-service-specific recording of the messages, produce fundamental advantages with regard to the management of the messages and the usability of the recorded messages. In this context, the communication management server provides a component which assigns an identity to the communication and thus enables the communication terminals to mark messages output via the communication services with the identity. This advantageously creates the prerequisite for recording the communication consisting of the messages of various ones of the communication services.

The arrangement according to the invention is advantageously designed such that the device for recording the messages output via the various communication services and marked with the identity are linked to the communication management server. This embodiment of the arrangement according to the invention is preferred since a recording of the messages by the communication management server avoids or minimizes changes in other network components.

The arrangement according to another embodiment of the invention can also be advantageously formed such that the device for recording the messages output via the various communication services and marked with the identity are in each case linked to a service center providing the respective communication services at the network end. As already stated in conjunction with the method according to the invention, this provides the advantage that the load of recording the messages output and marked with the identity is distributed to the various service centers. Furthermore, this dispenses with the necessity of conveying a copy of the relevant messages to the communication management server.

In still another embodiment of the arrangement according to the invention, the service center is linked to the communication management server for informing the communication management server about the messages marked with the identity. This advantageously enables the communication management server to manage the messages of a communication even in the case where the messages are recorded by the service center providing the respective communication service.

The communication management server of the arrangement according to the invention advantageously has a device for receiving information about the messages marked with the identity from the communication terminals. This embodiment is preferred since it enables the communication management server to manage the messages of a communication without these having to be recorded via the communication management server itself or requiring a transmission of corresponding information from the respective service center recording the messages to the communication management server.

The arrangement according to the invention is advantageously designed such that the communication management server has a device for receiving a replay request and a device for replaying one or more of the messages marked with the identity. This enables messages of the communication to be replayed and thus the communication to be tracked. In this context, the replay request can be preferably sent to the communication management server by the communication terminals involved in the communication and/or by other communication terminals.

In a preferred embodiment of the arrangement according to the invention, one of the service centers providing the various communication services is a server for a Push-to-Talk-Over-Cellular (PoC) service, an Instant Messaging (IM) service, an email service, a telephone service, a video telephony service, a Short Message Service (SMS) or a Multimedia Messaging Service (MMS). As already stated, the corresponding communication services are widely and frequently used services.

The arrangement according to the invention can also be advantageously arranged such that at least one of the communication terminals is a mobile communication terminal of a mobile radio network. This provides the advantage that it provides for mobility of the users.

The invention also relates to a communication management server for carrying out a communication method involving several users.

According to still another embodiment of the invention, there is a communication management server for carrying out a communication method involving several users for recording a communication, using different communication services in chronological sequence, between these several users comprising a device for receiving a request message from a communication terminal of one of the users, a device for assigning an identity to the communication and a device for answering the request message by transmitting the identity to the relevant communication terminal.

The communication management server according to another embodiment of the invention offers the advantage that it is designed for assigning the identity to the communication and for conveying the identity to the requesting communication terminal. In this arrangement, the assignment of the identity forms the prerequisite for the possibility that a communication between several users, which makes use of different communication services is in a chronological sequence, can be recorded.

In a preferred embodiment, the communication management server according to the invention has a device for recording messages output via the different communication services and marked with the identity. The recording of the messages by the communication management server offers the advantage that the recording of the messages does not require any changes, or only slight changes, of other network components.

The communication management server according to an embodiment of the invention preferably has a device for receiving the outgoing messages marked with the identity from the communication terminals. In this arrangement, the communication management server preferably supports the formats or protocols, respectively, of all available communication services.

In a further preferred embodiment, the communication management server according to the invention has a device for receiving information about the messages marked with the identity from a service center providing the respective communication service at the network end. This advantageously enables the communication management server to indicate information about the messages in the case where it does not handle the recording of the messages. Such information can be, for example, date and clock time, data volume and/or length or transmitter and/or receiver of the messages.

In a further embodiment of the invention, the communication management server has a device for receiving information about the messages marked with the identity from the communication terminals. This enables the communication management sever to manage and indicate information about the messages marked with the identity in the case where the communication management server does not itself store the messages, wherein a transmission of the corresponding information from a service center providing the respective service is not required.

The communication management server according to an embodiment of the invention can also be preferably designed such that it has a device for receiving a retrieval message and a device for answering the retrieval message by conveying the identity of the communication and/or of a list of the messages belonging to the communication and marked with the identity. This advantageously enables the communication terminals involved in the communication or also other communication terminals to search the communication and/or the messages of the communication for particular criteria. In this context, a multiplicity of communication items having different identities is recorded. If the identity of the communication is known, it can be conveyed to the communication management server in the retrieval message. In addition, it is also conceivable that a communication is provided with a title and/or a category as part of the assignment of the identity. In this case, the retrieval message can also include search terms which can be used by the communication management server for searching through the titles of the communication items and/or the titles and/or the contents of the messages allocated to the communication items by means of the respective identities.

The communication management server according to another embodiment of the invention advantageously has a device for receiving a replay request and means for replaying one or more of the messages marked with the identity. This provides the advantage that, by playing one, several or also all messages of a communication, the communication can be tracked. This is of advantage both for the users involved in the communication and for other users not directly involved in the communication.

The communication management server according to still another embodiment of the invention has a storage device for managing a receiver list allocated to the identity with the communication-service-specific addresses of the users currently involved in the communication. This advantageously provides for central management of the receiver list by the communication management server.

In another embodiment, the communication management server has a device for receiving the identity of the communication from a communication terminal of a further user together with address information of the further user and means for entering an address or several addresses of the further user in the receiver list allocated to the identity. This provides the advantage that other users which were previously not involved in the communication can enter themselves in the receiver list and thus thereafter receive the messages provided with the identity of the communication.

The communication management server according to still another embodiment the invention preferably has a device for determining the address or the addresses from the received address information by using the so-called ENUM functionality. Using the ENUM functionality provides the advantage that for each of the users, only one directory number needs to be conveyed to the communication management server. This distinctly reduces the expenditure by the users particularly when using a multiplicity of different communication services.

The communication management server according to still another embodiment of the invention can also be advantageously designed such that it has a device for informing the communication terminals of the users about changes in the receiver list. Thus, the current receiver list is available to the communication terminals at any time.

In addition, the invention relates to a communication terminal for carrying out a communication method involving several users.

According to yet another embodiment of the invention, there is a communication terminal for carrying out a communication method involving several users, for recording a communication, using various communication services in chronological sequence between the several users, comprising at least one communication service, a device for sending a request message to a communication management server for assigning an identity to the communication, a device for receiving the identity from the communication management server and a device for marking with the identity messages output via the at least one communication service.

The communication terminal according to an embodiment of the invention is preferred since it enables messages output via the at least one communication service of the communication terminal to be marked with the identity. In this context, the user using the communication terminal is preferably provided with the possibility of specifying individually for each message whether and, if necessary, with what identity it is to be marked.

In a preferred embodiment, the communication terminal according to the invention has a device for additionally conveying the outgoing messages marked with the identity to the communication management server. This advantageously enables the communication management server to record the corresponding messages.

The communication terminal according to the invention can also be advantageously designed such that it has a device for conveying information about the messages marked with the identity to the communication management server. This provides the advantage that information about the messages marked with the identity can be indicated to the communication management server even in the case where the messages are recorded by the respective service center and, therefore, not the complete messages are conveyed to the communication management server.

Furthermore, the communication terminal according to the invention can preferably have a device for sending a retrieval message to the communication management server for conveying the identity of the communication and/or of a list of the messages belonging to the communication and marked with the identity. This embodiment is preferred since it enables the communication terminal to interrogate information relating to the communication from the communication management server.

The communication terminal according to the invention preferably has a device for sending a replay request for replaying one or more of the messages marked with the identity to the communication management server. This advantageously enables individual or all messages of the communication to be tracked.

The communication terminal according to the invention can also be advantageously designed such that it has a device for conveying the identity of the communication, together with address information, to the communication management server for the entering of at least one address in the receiver list by the communication management server. This advantageously enables the user using the communication terminal to register for the communication in such a manner that he receives future messages provided with the identity.

In a preferred embodiment, the communication terminal according to the invention has a device for receiving changes in the receiver list from the communication management server. This advantageously enables the communication terminal to store, and to use when sending out messages marked with the identity, in each case a current version of the receiver list.

The communication terminal according to the invention can also be advantageously formed such that it has a device for retrieving the receiver list from the communication management server before sending the outgoing messages marked with the identity. This embodiment is advantageous since it enables the current receiver list to be used, avoiding the storage of copies of the receiver list on the communication terminals in addition to the receiver list stored in the communication management server.

In a preferred embodiment, the communication terminal according to the invention is a mobile communication terminal of a mobile radio network. In this context, the mobile communication terminal can be one according to an arbitrary radio standard such as, for example, the GSM (Global System for Mobile Communication) standard, the UMTS (Universal Mobile Telecommunication System) standard, the CDMA (Code Division Multiple Access) standard, the Bluetooth standard or the DECT (Digital Enhanced Cordless Telecommunications) standard.

### BRIEF DESCRIPTION OF THE DRAWINGS

The invention is detailed below with reference to the exemplary embodiments, in which:

FIG. 1 shows an embodiment of the arrangement with an embodiment of the communication management server and an embodiment of the communication terminal according to the invention.

FIG. 2 shows an embodiment of the arrangement with an embodiment of the communication management server and an embodiment of the communication terminal according to the invention.

FIG. 3 shows an embodiment for illustrating the method according to the invention.

### DETAILED DESCRIPTION OF THE INVENTION

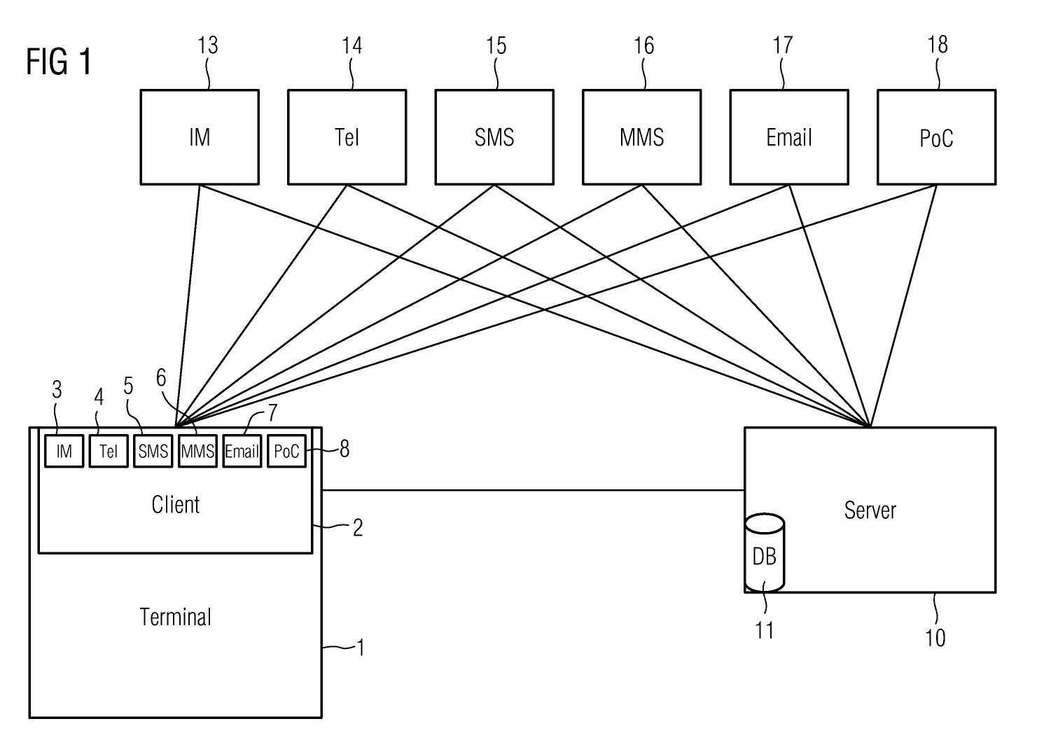

FIG. 1 shows a communication terminal 1, called terminal, in the form of a mobile radio telephone. As an alternative, the communication terminal 1 could also be, for example, a mobile computer (laptop) or a so-called Personal Digital Assistant (PDA) provided with a radio interface. The communication terminal 1 supports various communication services 3-8 via which messages can be exchanged with arbitrary other communication terminals, not shown in FIG. 1 for reasons of clarity. For example, FIG. 1 shows the communication services Instant Messaging (IM) 3, telephony 4, Short Message Service (SMS) 5, Multimedia Messaging Service (MMS) 6, email 7 and Push-to-Talk-Over-Cellular (PoC) 8 as communication services supported by the communication terminal 1. In this context, a communication service is understood by the communication terminal 1 to be a so-called client which supports the sending out and the reception of corresponding messages.

In the communication network used by the communication terminal 1, a communication service is usually provided by a service center 13-18. Such a service center 13-18 receives for the communication terminal 1 certain messages from other communication terminals and conveys these to the communication terminal 1 or, more precisely, to the corresponding communication services 3-8 of the communication terminal 1. Similarly, messages are sent out by the communication terminal 1 by using one of the communication services 3-8 in such a manner that the message is transferred to the relevant service center 13-18 and forwarded by it to one or more receivers of the message.

In accordance with the communication services supported by the communication terminal 1, FIG. 1 in each case shows a service center at the network end for Instant Messaging 13, conducting a telephone call 14, Short Message Service (SMS) 15, Multimedia Messaging Service (MMS) 16, email 17 and Push-to-Talk-Over-Cellular (PoC) 18.

Connections of the communication terminal 1 or of the communication service 3-8 used by it, to the respective service centers 13-18 are indicated in FIG. 1 by corresponding connecting lines between the communication terminal 1 and the service centers 13-18. It should be pointed out that these connections are usually not permanent connections but those which are in each case set up for transmitting a message. In this context, it should also be noted that the corresponding connections can be both circuit-switched and packet-switched connections. Particularly in the case of a packet-switched connection, this is less a connection in the traditional sense than a connecting path via which data packets can be conveyed.

Apart from the communication terminal 1 and the service centers 13-18, the arrangement in FIG. 1 has a communication management server 10 called server. The communication management server 10 is connected to the service centers 13-18 and to the communication terminal 1. It should be pointed out at this point that there will usually be a multiplicity of other communication terminals, the arrangement of which corresponds to the communication terminal 1. This means that both the service centers 13-18 and the communication management server 10 are arranged for simultaneously supporting a multiplicity of communication terminals.

In the illustrative embodiment shown in FIG. 1, the communication terminal 1 has a software client 2 called client, which encapsulates the various communication services 3-8 of the communication terminal 1. In this context, the software client 2 provides at the communication terminal 1 the functionality which is required for recording and managing messages. If a user wishes to use a functionality supported by the communication management server 10, he starts the software client 2 on the communication terminal 1 used by him. Thus, for instance, the software client 2 allows the user, for instance, to declare the affiliation of a message output via the communication services 3-8 with a communication. In this context, a communication is a coherent conversational thread which extends over a number of the communication services 3-8. If, in contrast, the user wishes to send out messages which do not belong to a communication, he uses the communication terminal 1 in conventional manner, i.e. without using the software client 2.

If the software client 2 of the communication terminal 1 is activated by the user, it provides the following functions:
1. setting up a new communication relating to a subject to be named by the user,
2. searching for and booking a communication,
3. selecting a booked communication for reading and writing.

### 1. Setting Up a New Communication Relating to a Subject to be Named by the User

If a user wishes to record a new communication, i.e. a new conversational thread, he selects the corresponding function on the software client 2 of the communication terminal 1. The user is then provided with the possibility of specifying a subject or a title for the communication. The software client 2 of the communication terminal 1 thereupon sends a request message to the communication management server 10. The latter thereupon assigns an identity to the communication and answers the request message by conveying the identity to the communication terminal 1. The software client 2 of the communication terminal 1 stores the identity assigned to the communication and can thus mark with this identity messages output via the various communication services 3-8 of the communication terminal 1.

On the basis of the request message, the communication management server 10 sets up a new communication with the identity assigned by it. The consequence is that the communication management server 10 allocates all messages arriving in future, which are marked with the corresponding identity, to the relevant communication, i.e. records them in such a manner that the messages can be retrieved via the identity. In addition, the possibility advantageously exists that the communication management server 10 already books the relevant communication when assigning the identity for the user of the communication terminal 1 sending the request message, i.e. includes the subscribing user in a receiver list for all messages marked with the identity. A corresponding receiver list is preferably created on assignment of the identity to the communication by the communication management server 10.

In addition to naming the subject of the communication, it is advantageously possible that the user setting up the communication specifies a validity period for the communication. This can be additionally conveyed by the communication terminal 1 or its software client 2, respectively, to the communication management server 10. It provides the advantage that the communication management server 10 can delete expired communication items or expired messages from communications. In this context, it must be taken into consideration that the communication management server 10, as a rule, will manage a multiplicity of communication items so that a mechanism for deleting older communication items or older messages is sensible or required, respectively.

### 2. Searching for and Booking a Communication

Apart from setting up a new communication, the user of the communication terminal 1 has the possibility, by means of the software client 2, to search for an existing communication and, if necessary, to book it, i.e. to have himself included in the receiver list for messages marked with the identity of the communication. If the user selects the corresponding function of the software client 2, the latter sends a retrieval message to the communication management server 10. The latter answers by conveying the identity of the communication and/or of a list of the messages belonging to the communication and marked with the identity. In this context, the retrieval message can contain a search request in any arbitrary form. If the corresponding identity is known to the user, the identity can be conveyed to the communication management server 10 in the retrieval message. If an identity is not known to the user, he can formulate, for example, a search request in the form of search terms in the retrieval message, in which the title of the communication items and/or the associated messages or the associated messages themselves are searched by the communication management server 10.

In the illustrative embodiment shown in FIG. 1, the communication management server 10 records all messages output via the communication services 3-8 of the communication terminal 1 and marked with the identity. This is done with the aid of means linked to the communication management server 10 for recording 11 in the form of a database which is arranged as part of the communication management server 10 in the illustrative embodiment of FIG. 1. Thus, the communication management server 10 handles not only the management of the communication items but also the recording of the messages allocated to the communication items in the illustrative embodiment of FIG. 1.

After receiving the answer to the retrieval message from the communication management server 10, the user, by using the software client 2 of the communication terminal 1, selects a communication and conveys the identity of this communication, together with his address information, to the communication management server 10. The communication management server 10 thereupon enters an address or several addresses of the user into the receiver list of the corresponding communication. It should be pointed out that the user, and thus also the communication terminal 1 of the corresponding user who books a communication in this manner, will be, as a rule, not the user or the communication terminal 1 of the user, respectively who or which has set up the communication by means of the request message. For reasons of clarity, however, FIG. 1 only shows a communication terminal 1 which is used for illustrating the various functions.

In general, it should be noted that the various communication services 3-8, as a rule, need different addresses. Thus, the addresses can be, for example, a directory number, an email address or an IP (Internal Protocol) address. For this reason, the address information items conveyed by the communication terminal 1 to the communication management server 10 can contain different addresses specific to the respective communication services 3-8. As an alternative, the user can also convey only one significant address to the communication management server 10 in the address information. In this case, the possibility exists that the communication management server 10 determines by means of the so-called ENUM functionality (see IETF RFC 3761) the other addresses of the relevant user or of the communication services 3-8 used by him, of the communication terminal 1 and uses them for the future forwarding of the messages marked with the identity of the communication.

As soon as the address or the addresses of the user is or are entered in the receiver list allocated to the communication on the communication management server 10, all future messages marked with the identity are conveyed to the relevant user. In this context, it must be noted that a particular user will normally use only one communication terminal 1 with communication services 3-8. In addition, however, it is also possible that a user at least partially also uses different communication terminals for different communication services. Thus, it can be established with the aid of the address information, for example, that emails are conveyed to the workstation computer of the user whereas messages of other communication services are conveyed to a mobile radio telephone of the user.

It is another important functionality of the communication management server 10 to inform the communication terminal 1 or generally all communication terminals entered in the receiver list about changes in the receiver list. A corresponding notification is required, for example, when a user is newly added to or deregistered from the communication. The distribution of the current receiver list is of importance since all communication terminals 1 send outgoing messages marked with the identity of the communication to this receiver list. As an alternative, the communication terminal 1 can also interrogate the current receiver list from the communication management server 10 before sending out a message. In the illustrative embodiment shown in FIG. 1, the receiver list allocated to the communication is deposited, together with the identity of the communication and the associated messages, in the means for storing 11 in the form of the database.

Analogously to the booking, a user is deregistered by deleting the address or the addresses of the relevant user in the receiver list in the communication management server 10. This is again triggered by a control message of the software client 2 of the corresponding communication terminal 1.

### 3. Selecting a Booked Communication for Reading and Writing

A further function of the software client 2 consists in enabling the messages allocated to the communication and marked with the identity to be read and written. As already stated previously, the software client 2 precedes the communication services 3-8 of the terminal. If the user wishes to write a contribution to the communication, he first selects the corresponding communication in accordance with the procedure described before. In addition, the user specifies from the communication services 3-8 the one which he wishes to use for the new message. The software client 2 ensures that the message is not only conveyed to the users entered in the receiver list but is especially also recorded, and allocated to the communication with the corresponding identity, independently of the communication service used. For communication services which are already message-based per se such as, for example, E-mail, SMS, IM or MMS, the software client 2 of the communication terminal 1 additionally includes the communication management server 10 in the receiver list. As an alternative, the communication management server 10 can also be already entered in the receiver list managed by it itself. In both cases, this leads to all messages being forwarded not only to the receiver list but “automatically” also to the communication management server 10 for the purpose of recording.

If the charging is based on the number of messages actually sent out by the communication terminal 1 as is the case, for example, in the SMS communication service, it is possible that in the charging system, the sending of corresponding messages to the communication management server 10 is free of cost. In other communication services such as, for example, email, the message is duplicated by the email server 17 and thus not actually sent out several times by the communication terminal 1.

For telephone calls, the recording is done by the software client 2 of the communication terminal 1 setting up a conference circuit in which the communication management server 10 is included as additional passive user. This enables the communication management server 10 to record the relevant message in the form of the telephone call.

The messages or message copies received by the communication management server 10 are advantageously marked with the identity of the communication by means of so-called in-band signaling. In this process, the identity of the communication is embedded in the message. This can be done, for example, by means of a character string at the beginning of the message. In the case of a telephone call, the software client 2 of the communication terminal 1 of the user setting up the call first calls the communication management server 10, as already stated, and conveys to it the identity, for example by means of the DTMF (Dual Tone Multiple Frequency) method. After that, the user setting up the call calls the further user or users and switches the conference. The advantage of such in-band signaling consists in that this does not disturb the actual call. Furthermore, in-band signaling works universally and is not coupled to particular prerequisites. In-band signaling also does not require any adaptation to existing communication services as a result of which maximum compatibility with the existing methods is achieved.

The software client 2 of the communication terminal 1 can advantageously filter out the identity of the communication from received messages in order to avoid errors in the reproduction of the messages. This can happen, for example, due to the first n positions of the message being cut off. This prevents the identity of the communication from being indicated to the user as part of the message, for example in the case of messages such as an SMS. The communication management server 10, in turn, can identify the associated communication by means of the identity embedded in each one of the messages received by it and thus correctly store the messages.

Apart from in-band signaling, so-called out-of-band signaling is also conceivable at least for some communication services. This can be done, for example, by additional header information being inserted into the messages by the respective software client 2 of the relevant communication terminal 1, which are evaluated by the communication management server 10. Furthermore, the identity can be transmitted to the communication management server 10 via an additional connection between the communication terminal 1 and the communication management server 10 outside the actual transmission of the messages.

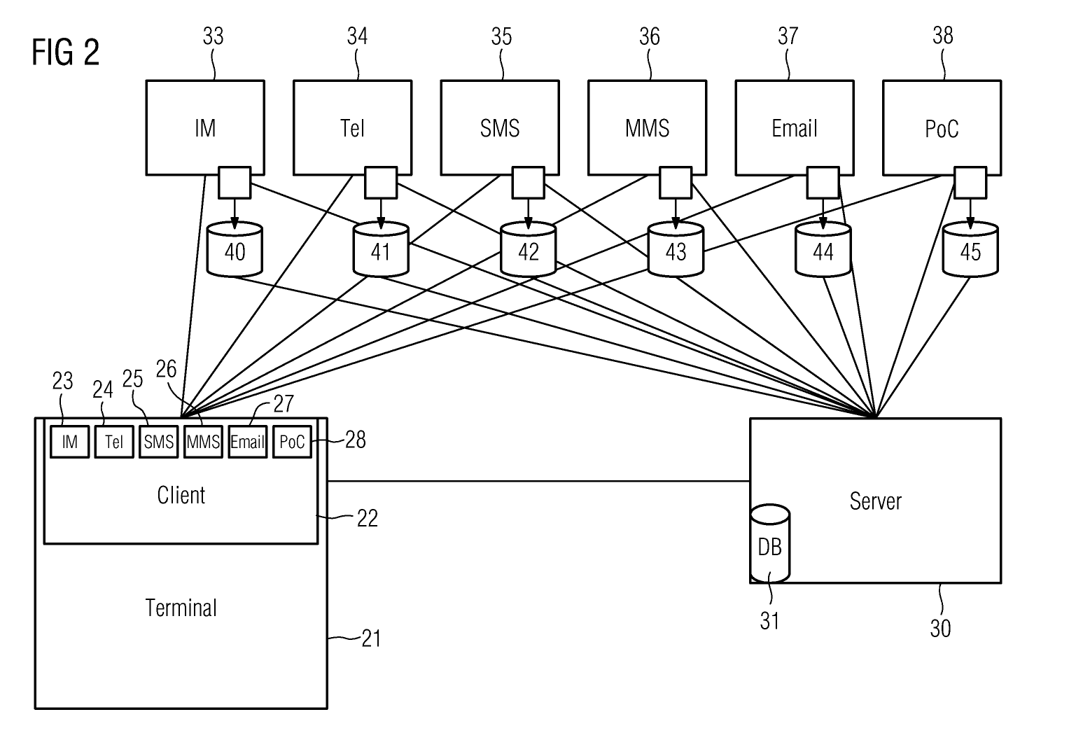

FIG. 2 shows a second illustrative embodiment of the arrangement according to the invention with an illustrative embodiment of the communication management server according to the invention and an illustrative embodiment of the communication terminal according to the invention. Analogously to FIG. 1, FIG. 2 shows a communication terminal which has a software client 22. The software client 22 again encapsulates the various communication services 23-28 or, to put it more precisely, the clients of the corresponding communication service at the terminal end. In addition, several service centers 33-38 and one communication management server 30 are shown in FIG. 2. The communication management server 30 has a storage device 31 for managing a receiver list allocated to the identity, with addresses of the current users involved in the communication.

Whereas in the illustrative embodiment of FIG. 1, the focus of implementation is essentially on the communication terminal 1 and the communication management server 10, the focus in the variant of the embodiment of FIG. 2 is on an implementation in the network, i.e. on the service centers 33-38 which are involved in the implementation of the individual communication services supported in the overall system. The service centers 33-38 implement either a so-called store-and-forward functionality, or real-time call processing, for the various communication services. With regard to the recording of messages marked with an identity, both functionalities must be supported. For this purpose, the corresponding standard network elements which are normally used as service centers such as, for example, an SMSC (Short Message Service Center), an MMSC (Multimedia Messaging Service Center), a PoC server or an IM server must be extended by a component which records the messages and renders them retrievable. In the illustrative embodiment of FIG. 2, the function of recording is thus handled not by the communication manager 30 but is the responsibility of service centers 33-38 of the individual communication services supported. This embodiment has the advantage that the load of storing and transmitting the messages is distributed over the entire system.

To enable the messages to be recorded, the service centers 33-38 have new hardware and/or software components which are connected to means for recording 40-45 the messages output via the various communication services 23-28 and marked with the identity. The corresponding hardware or software is indicated by the blocks arranged between the respective service centers 33-38 and respective means for recording 40-45 in FIG. 2.

In the illustrative embodiment shown in FIG. 2, too, the communication management server 30 manages the communication. This includes monitoring of the states of the communications (e.g. in the case of communications with expired validity period) and coordinating incoming request and retrieval messages and incoming replay requests. For replay purposes, however, the messages are retrieved by the communication management server 30 from the means for recording 40-45 linked to the service centers 33-38, in contrast to the illustrative embodiment of FIG. 1. In this context, the relevant messages are preferably conveyed by the service centers 33-38 to the communication management server 30 and transmitted by the latter to the communication terminal 21 requesting the replay. As an alternative, the communication management server 30 can also instruct the service centers 33-38 to convey the relevant messages directly to the communication terminal 21.

Analogously to the procedural sequence described in conjunction with FIG. 1, users can also set up new communications in the variant of an embodiment shown in FIG. 2 by requesting an identity from the communication management server 30 by means of the communication terminal 21. Correspondingly, the users can also send out messages marked with the identity. In contrast to FIG. 1, however, the communication management server 30 is not installed in the communication as additional receiver in the illustrative embodiment of FIG. 2, in order to handle the recording or storing of the copy of the message and ensure the correlation with the identity. Instead, the identity of the communication is signaled in the setting-up phase of the communication service currently being used, in order to initialize the means for recording 40-45 in the corresponding service center 33-38. In the further procedure, the identity is then received and evaluated by the relevant service center 33-38 of the respective service and the message is stored together with the identity in the means for recording 40-45. To avoid or to keep down changes of existing standards if possible, this is preferably done in a separate database which is not identical to the database which is used by the service center 33-38 itself for providing the respective communication service. This results in a decoupling of the respective communication service from the communication management server 30 which can go so far that the interface from the respective service center 33-38 to the respective database is designed to be unidirectional in order to eliminate any impairment during the provision of the communication services.

In the illustration embodiment of FIG. 2, the communications are otherwise managed largely analogously to the illustrative embodiment shown in FIG. 1. This particularly relates to the booking, the selecting and the reading or writing of the communication. In this context, however, there are preferably at least two interfaces between the communication management server 30 and the respective service centers 33-38 to be supported. One of the two interfaces is used for retrieving the messages marked with the identity from the means for recording 40-45, using the desired identity of the communication as index. In addition, there is a further interface via which the service centers 33-38 notify the communication management server 30 when new messages arrive. This interface is thus a signaling interface. This is required since, in contrast to the illustrative embodiment of FIG. 1, the communication management server 30 does not itself receive the messages marked with the identity. It is therefore the task of the service centers 33-38 to inform the communication management server 30 about new contributions for communications, i.e. conversational threads. As an alternative, however, the communication terminal 21 sending the respective message can also inform the communication management server 30, by means of the software client 22 integrated in it, about the new message for the communication via a signaling channel.

Both the variant of an embodiment of FIG. 1 and that of FIG. 2 provide the advantage that messages belonging to a communication and provided via various communication services can be recorded. In this context, an extension by further communication services can be provided in a simple manner. By this means, the communication with other users, for example a group, can be distinctly improved and systematically arranged. Newly arrived users thus do not have to be informed again about details or facts already communicated. All users of a communication have the possibility of providing themselves with an overview of the status without disturbing the other users. This can be done at any time. To suitably organize the various functionalities and adapt them to existing habits of the users, a web interface is advantageously used.

For a network operator, the recording of the messages provides a possibly attractive distinguishing feature with respect to other network operators. In this context, the embodiment of FIG. 1, in particular, provides the possibility of checking the acceptance of the recording of the communications on the market without requiring extensive extensions of existing communication services and existing service centers. Performance problems in storing and searching for the communications or the messages allocated to them, as can possibly arise with a very great utilization of the functionality, which may arise when using an arrangement according to FIG. 1, can be avoided with the aid of the arrangement according to the illustrative embodiment according to FIG. 2. However, this variant of the embodiment requires that existing communication services are extended to such an extent that the service centers actively support the corresponding functionality.

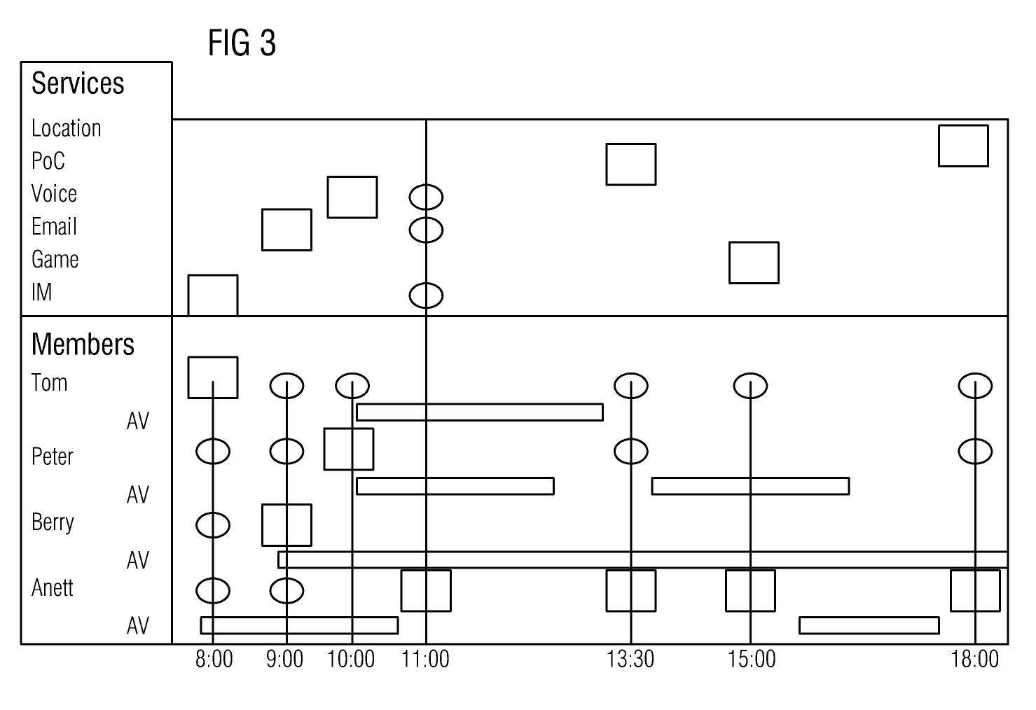

FIG. 3 shows in a diagrammatic sketch an illustrative embodiment for illustrating the method according to the invention. In the upper area of the figure, various communication services used by users are listed. These communication services are a location information service “location, a Push-to-Talk-Over-Cellular service “PoC”, a voice telephony service “voice”, an email service “email”, a games service “game” and an Instant Messaging service “IM”.

In the lower part of FIG. 3, users of a communication “members” are listed. These are Tom, Peter, Berry and Anett. The time axis is shown horizontally, i.e. FIG. 3 shows the chronological sequence of a communication from 8:00 am to 6:00 pm. The rectangles in the block of communication services in each case show the active communication service and in the block of users in each case show the active user sending a message. The ellipsoid symbol marks the receiver of a message in the block of users or, respectively, the communication service, providing a particular recorded message, in the block of communication services.

In the block of users, the availability of the respective user is additionally shown as a function of time in the row AV. In this context, a user is not available in the period marked by the bar, i.e. cannot be reached by a message.

The day or the communication, respectively, between the various users proceeds as follows:

At 8:00 am, Tom (active user, marked by the rectangle) begins a new communication. For this purpose, he requests a new identity from a communication management server and issues the title “shall we meet this evening and do you have any suggestions as to what we want to do?” for this communication. It is thus the aim of Tom to meet the receivers of the message this evening. For this purpose, he uses an Instant Messaging service (the active communication service is the IM service, marked by a corresponding rectangle). Berry, Anett and Peter are receivers of the message (passive users, marked by an ellipse), i.e. they were entered in the receiver list by Tom when he set up the communication. As an alternative, a receiver list already existing can be allocated to the communication. In accordance with the capabilities of the IM communication service, the receivers read the message as soon as they have switched on their communication terminal and their status is ready to receive.

At 9:00 am, Berry, using her mobile radio telephone, responds by means of the email communication service in order to call off her further participation in the communication. She is on a business trip and can therefore not participate in the planned activity.

At 10:00 am, Peter (initiator of the call, marked by a rectangle) calls Tom (ellipse, receiver) in order to talk over what they can do. Anett is not ready to receive but the telephone server of the voice service records the conversation (rectangle at voice service).

At 11:00 am, Anett switches on her communication terminal and sees that Tom has opened a communication in which she also wishes to participate now. She would like to inform herself about its previous course and, for this purpose, can have the previous messages displayed or replayed, respectively, by a corresponding enquiry at the communication management server. For this purpose, the communication management server retrieves the messages from the respective service center. Anett is here active (rectangle) and the communication services hitherto used, or their service centers, respectively, provide the previous messages of the communication (ellipses at the voice telephony service, at the email service and at the IM service).

Since at 1:30 pm, all possible users still remaining are available, Anett (rectangle) initiates a Push-to-Talk-Over-Cellular call and speaks to Tom and Peter (ellipses). During this call, the PoC service records the message in the form of the conversation (rectangle at PoC service).

At 3:00 pm, Anett (rectangle) starts a games service with Tom (ellipse). Since Peter is not available, he does not participate in the game. The game service (rectangle) logs the game so that Peter can follow the course of the game later, if necessary.

Around 6:00 pm Anett (rectangle) arrives at the agreed meeting point and would like to know if she still has to wait for a long time. If this should be so, she would like to go and have a cup of coffee. Using the location service (rectangle), however, she finds that both Peter and Tom are already in her vicinity and therefore decides to wait for them both.

1. A method for communicating and recording communications between a plurality of users using communication services, comprising:
sending a request message from a communication terminal of one of the plurality of users to a communication management server;
assigning an identity to the communication via the communication management server and answering the request message by conveying the identity to the communication terminal;
marking messages, output via the communication services of the communication terminals of the plurality of users, with the identity by the respective communication terminal; and
recording the messages output via the communication services and marked with the identity such that the messages can be retrieved via the identity.

2. The method as claimed in claim 1, wherein the messages output via the communication services and marked with the identity are recorded by the communication management server.

3. The method as claimed in claim 2, wherein
the outgoing messages marked with the identity are additionally conveyed by the communication terminals to the communication management server.

4. The method as claimed in claim 3, wherein the conveying of the messages marked with the identity to the communication management server (10) is provided free of costs in the charging system.

5. The method as claimed in claim 1, wherein the messages output via the various communication services and marked with the identity are recorded by a service center providing the respective communication service at the network end.

6. The method as claimed in claim 5, wherein the service center informs the communication management server about the messages marked with the identity.

7. The method as claimed in claim 5, wherein the communication terminal sending out the respective message output and marked with the identity informs the communication management server about the message marked with the identity.

8. The method as claimed in claim 1, further comprising:
sending a retrieval message to the communication management server; and
answering the communication management server by conveying the identity of the communication and/or of a list of the messages belonging to the communication and marked with the identity.

9. The method as claimed in claim 1, further comprising:
sending a replay request to the communication management server; and
replaying one or several of the messages marked with the identity by the communication management server.

10. The method as claimed in claim 1, wherein the communication management server, for sending the messages marked with the identity, manages a receiver list, allocated to the identity, with addresses of the users currently involved in the communication.

11. The method as claimed in claim 10, wherein the receiver list is set up by the communication management server concurrently with the assignment of the identity.

12. The method as claimed in claim 10, further comprising:
conveying the identity of an existing communication by a communication terminal of an another user of the plurality of users, together with address information of the further user, to the communication management server; and
entering at least one address of the another user in the receiver list by the communication management server.

13. The method as claimed in claim 12, wherein the communication management server determines from the address information the address or the addresses by using ENUM functionality.

14. The method as claimed in claim 10, wherein the communication management server informs the communication terminals of the users about changes in the receiver list.

15. The method as claimed in claim 10, wherein the communication terminals, before sending the messages marked with the identity, retrieve the receiver list from the communication management server.

16. The method as claimed in claim 1, wherein in addition to the content of the messages marked with the identity, information relating to the time and/or to the receivers of the messages is recorded.

17. The method as claimed in claim 1, wherein the communication is provided with a validity period, after expiry of which the communication or individual messages of the communication marked with the identity are deleted.

18. The method as claimed in claim 1, wherein reading and writing of the messages of the communication marked with the identity is regulated by access rights.

19. The method as claimed in claim 1, wherein a Push-to-Talk-Over-Cellular service, an Instant Messaging service, an email service, a telephone service, a video telephony service, a Short Message Service or a Multimedia Messaging Service is used as one of the various communication services.

20. The method as claimed in claim 1, wherein a mobile communication terminal of a mobile radio network is used as at least one of the communication terminals.

21. An arrangement for communicating and recording a communication using communication services between a plurality of users, comprising:
communication terminals allocated to the plurality of users, which in each case
provide at least one of the communication services (3-8; 23-28), and including:
a sending device for sending a request message to a communication management server for assigning an identity to the communication,
a receiving device for receiving the identity from the communication management server, and
a marking device for marking the identity messages output via the at least one communication service; and
the communication management server including:
a second receiving device for receiving the request message from one of the communication terminals,
an assigning device for assigning the identity to the communication, and
an answering device for answering the request message by transmitting the identity to the relevant communication terminal, and
a recording device for recording the messages output via the communication services and marked with the identity such that the messages can be retrieved via the identity.

22. The arrangement as claimed in claim 21, wherein the recording device records the messages output via the communication services and marked with the identity are linked to the communication management server.

23. The arrangement as claimed in claim 21, wherein the recording device records the messages output via the communication services and marked with the identity are in each case linked to a service center providing the respective communication service at the network end.

24. The arrangement as claimed in claim 23, wherein the service center is linked to the communication management server for informing the communication management server about the messages marked with the identity.

25. The arrangement as claimed in claim 23, wherein the communication management server has for a receiving device for receiving information about the messages marked with the identity from the communication terminals.

26. The arrangement as claimed in claim 21, wherein the communication management server has
a replay request device for receiving a replay request, and
a replay message device for replaying one or more of the messages marked with the identity.

27. The arrangement as claimed in claim 21, wherein one of the service centers providing various communication services is a server for a Push-to-Talk-Over-Cellular service, an Instant Messaging service, an email service, a telephone service (14; 34), a video telephony service, a Short Message Service or a Multimedia Messaging Service.

28. The arrangement as claimed in claim 21, wherein
at least one of the communication terminals is a mobile communication terminal of a mobile radio network.

29. A communication management server for recording a communication, using different communication services, between a plurality of users, comprising
a receiving device for receiving a request message from a communication terminal of one of the users;
an assignment device for assigning an identity to the communication; and
an answering device for answering the request message by transmitting the identity to the relevant communication terminal.

30. The communication management server as claimed in claim 29, further comprising a recording device for recording messages output via the communication services and marked with the identity.

31. The communication management server as claimed in claim 30, further comprising a device to receive the outgoing messages marked with the identity from the communication terminals.

32. The communication management server as claimed in claim 29, further comprising a device to receive information about the messages marked with the identity from a service center providing the respective communication service at the network end.

33. The communication management server as claimed in claim 29, further comprising a device to receive information about the messages marked with the identity from the communication terminals.

34. The communication management server as claimed in claim 29, further comprising
a first device to receive a retrieval message, and
a second device to answer the retrieval message by conveying the identity of the communication and/or of a list of the messages belonging to the communication and marked with the identity.

35. The communication management server as claimed in claim 29, further comprising:
a first device receiving a replay request and
a second device replaying one or more of the messages marked with the identity.

36. The communication management server as claimed
claim 29, further comprising
a storage device for managing a receiver list, allocated to the identity, with addresses of the users currently involved in the communication.

37. The communication management server as claimed in claim 36, further comprising:
a first device for receiving the identity of the communication from a communication terminal of a further user together with address information of the further user, and
a second device for entering an address or several addresses of the further user in the receiver list allocated to the identity.

38. The communication management server as claimed in claim 37, further comprising a determining device for determining the address or the addresses from the received address information by using the so-called ENUM functionality.

39. The communication management server as claimed in claim 36, further comprising a device for informing the communication terminals of the plurality of users about changes in the receiver list.

40. A communication terminal for communicating and recording a communication, using communication services, between a plurality of users, comprising:
at least one communication service;
a sending device for sending a request message to a communication management server for assigning an identity to the communication;
a receiving device for receiving the identity from the communication management server; and
a marking device for marking with the identity messages output via the at least one communication service.

41. The communication terminal as claimed in claim 40, further comprising a conveying device conveying the outgoing messages marked with the identity to the communication management server.

42. The communication terminal as claimed in claim 40, further comprising a conveying device conveying information about the messages marked with the identity to the communication management server.

43. The communication terminal as claimed in claim 40, further comprising a device for sending a retrieval message to the communication management server for conveying the identity of the communication and/or of a list of the messages belonging to the communication and marked with the identity.

44. The communication terminal as claimed in claim 40, further comprising a replay request device for sending a replay request for replaying one or more of the messages marked with the identity to the communication management server.

45. The communication terminal as claimed in claim 40, further comprising a conveying device conveying the identity of the communication, together with address information, to the communication management server for the entering of at least one address in the receiver list by the communication management server.

46. The communication terminal as claimed in claim 45, further comprising a device for receiving changes in the receiver list from the communication management server.

47. The communication terminal as claimed in claim 45, further comprising a device for retrieving the receiver list from the communication management server before sending the outgoing messages marked with the identity.

48. The communication terminal as claimed in one of claims 40, where the communication terminal is a mobile communication terminal of a mobile radio network.
